(19) United States
(12) Patent Application Publication
(10) Pub. No.: US 2024/0280975 A1
(43) Pub. Date: Aug. 22, 2024

(54) AUTOMATED ARTIFICIAL INTELLIGENCE (AI) INSPECTION OF CUSTOMIZED PART PRODUCTION

(71) Applicant: Kyndryl, Inc., New York, NY (US)

(72) Inventor: Sheela SIDDAPPA, Bengaluru (IN)

(21) Appl. No.: 18/112,574

(22) Filed: Feb. 22, 2023

(51) Int. Cl. G05B 19/418; G05B 13/02

(52) U.S. Cl. CPC G05B 19/41875; G05B 13/0265; G05B 2219/32368

(57) ABSTRACT

Aspects of the present disclosure relate generally to machine inspection of part production and, more particularly, to systems and methods of automated Al inspection of customized part production. For example, a computer-implemented method includes receiving, by a processor, design information for a custom part; extracting, by the processor, feature information of the custom part from the design information; receiving, by the processor, images of the custom part in production from a recording in near real time; and verifying, by the processor, using machine learning that features in the images of the custom part in production are in compliance with the feature information of the custom part.

### BACKGROUND

Aspects of the present invention relate generally to machine inspection of part production and, more particularly, to systems and methods of automated artificial intelligence (AI) inspection of customized part production.

Customers increasingly desire customized products and services. Continuous technological advancements in materials and production methods have supported this trend by providing the capability to customize an ever-increasing variety of products. As a result, producing customized products quickly and accurately has become a competitive necessity for many businesses. This production of custom products to meet demand is expected to grow unabated for some time.

### SUMMARY

In a first aspect of the invention, there is a computer-implemented method including: receiving, by a processor, design information for a custom part; extracting, by the processor, feature information of the custom part from the design information; receiving, by the processor, images of the custom part in production from a recording in near real time; and verifying, by the processor, using machine learning that features in the images of the custom part in production are in compliance with the feature information of the custom part.

In another aspect of the invention, there is a computer program product including one or more computer readable storage media having program instructions collectively stored on the one or more computer readable storage media. The program instructions are executable to: receive, by a processor, images of a custom part in production from an initial video recording in near real time; input, by the processor, the images of the custom part in production into a convolutional neural network model that determines features in the images of the custom part are similar with feature information of the custom part; receive, by the processor, an indication from the convolutional neural network model that a feature in the images of the custom part in production is not similar with the feature information of the custom part; and output, by the processor, an alert to a computing device in response to receiving the indication that the custom part in production is not in compliance with the feature information of the custom part.

In another aspect of the invention, there is a system including a processor, a computer readable memory, one or more computer readable storage media, and program instructions collectively stored on the one or more computer readable storage media, the program instructions executable to: receive, by the processor, images of a custom part in production from an initial video recording in near real time; input, by the processor, the images of the custom part in production into a machine learning model that determines features in the images of the custom part are similar with feature information of the custom part; receive, by the processor, an indication from the machine learning model that a feature in the images of the custom part in production is not similar with the feature information of the custom part; and output, by the processor, an alert to a computing device in response to receiving the indication that the custom part in production is not in compliance with the feature information of the custom part.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment in accordance with aspects of the invention.

FIG. 3 depicts abstraction model layers in accordance with aspects of the invention.

FIG. 4 shows a block diagram in an exemplary environment in accordance with aspects of the invention.

FIGS. 5A and 5B depict illustrations of exemplary custom parts in accordance with aspects of the invention.

FIG. 6 depicts an illustration of an exemplary process flow diagram in accordance with aspects of the invention.

FIG. 7 depicts an illustration of an exemplary process flow diagram in accordance with aspects of the invention.

FIG. 8 depicts an illustration of an exemplary model in accordance with aspects of the invention.

FIG. 9 shows a flowchart of an exemplary method in accordance with aspects of the invention.

### DETAILED DESCRIPTION

Aspects of the present invention relate generally to machine inspection of part production and, more particularly, to systems and methods of automated artificial intelligence (AI) inspection of customized part production. More specifically, aspects of the invention relate to methods, computer program products, and systems for extracting features for a custom part from design data, verifying that the custom part features during subprocesses of production are in compliance with the features of the custom part extracted from the design data, and generating alerts for noncompliance of features during subprocesses of production. For instance, a feature that is a hole with a certain diameter in a specific location of the custom part in production is in compliance if the same feature is found in a similar location with a similar diameter in the design data of the custom part.

Implementations of the invention apply machine learning to images of the custom part from a video recording of an initial production of the custom part in real time or near real time and verify that features in the images of the custom part from the video recording are in compliance with features extracted from design information of the custom part. Thus, when there is no prior learning available, implementations of the invention support inspection of the custom part during initial production. Implementations of the invention also apply machine learning to identify subprocesses in the initial production of the custom part from the images of the video recording of the initial production of the custom part in real time or near real time.

In embodiments, the methods, systems, and computer program products described herein receive design information for a custom part that includes feature information such as image data, geometric information, and dimension information. From the design information, embodiments of the methods, systems, and computer program products described herein extract features of the custom part. In embodiments, images from a real time or near real time video recording of the initial production of the custom part are input into a machine learning model that verifies that the features in the images of the custom part in the initial production are in compliance with the features extracted from the design information of the custom part. Alerts may be output when a feature in the images of the custom part in production is not in compliance with the features extracted from the design information of the custom part.

Aspects of the present invention are directed to improvements in computer-related technology and existing technological processes in automated AI inspection of customized part production. In embodiments, the systems, methods, and computer program product employ a machine learning model that verifies features of a custom part in initial production where there is no prior learning available. The machine learning model is trained in real time or near real time to identify subprocesses in the initial production of the custom part from images of the video recording of the initial production of the custom part. In embodiments, by using a machine learning module, a convolutional neural network model, a video analysis module, and an image analysis module, the systems, methods, and computer program product extract features of the custom part from design information, input images from a real time or near real time video recording of the initial production of the custom part into the convolutional neural network model that verifies the features in the images of the custom part in the initial production are in compliance with the features extracted from the design information of the custom part, and outputs alerts when a feature in the images of the custom part in production is not in compliance with the features extracted from the design information of the custom part. These are specific improvements in the way computers may operate and interoperate to automate AI inspection of customized part production that go beyond the features in known systems.

In general, convolutional neural networks (CNNs) are a type of neural network primarily used for pattern recognition tasks in image processing. Typically, CNNs are comprised of three types of stacked layers: convolutional layers, pooling layers and fully-connected layers. Each convolutional layer has its own set of convolution kernels that learns features of the image independently. The pooling layers perform downsampling that reduces the number of parameters between convolutional layers. The fully-connected layers receive the feature analysis from the convolutional and pooling layers and connect hidden layers to the output layer by applying weights to predict the output decision about the image as a whole.

Implementations of the invention describe additional elements that are specific improvements in the way computers may operate and these additional elements provide non-abstract improvements to computer functionality and capabilities. As an example, implementations of the invention apply machine learning to images of the custom part from video recording of an initial production of the custom part in real time or near real time and verify that features in the images of the custom part from the video recording are in compliance with features extracted from design information of the custom part. A computer, computer system, and/or computer program product including one or more computer readable storage media having program instructions collectively stored on the one or more computer readable storage media receive images of a custom part in production from an initial video recording in real time or near real time, input the images of the custom part in production into a convolutional neural network model that determines features in the images of the custom part are similar with feature information of the custom part, receive an indication from the convolutional neural network model that a feature in the images of the custom part in production is not similar with the feature information of the custom part, and output an alert to a computing device that the custom part in production is not in compliance with the feature information of the custom part. These examples of additional elements provide non-abstract improvements to computer functionality and capabilities.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

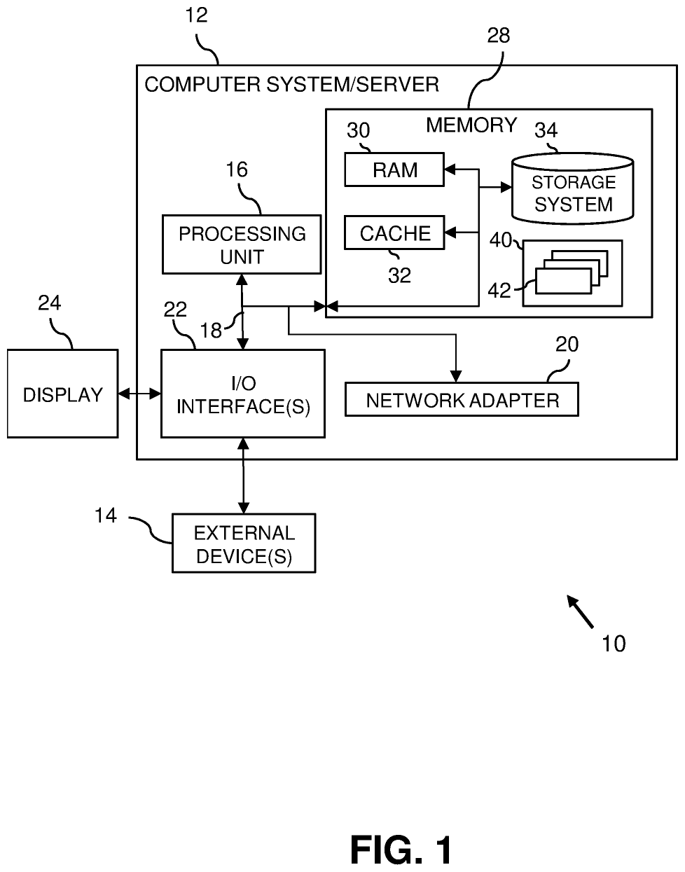

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

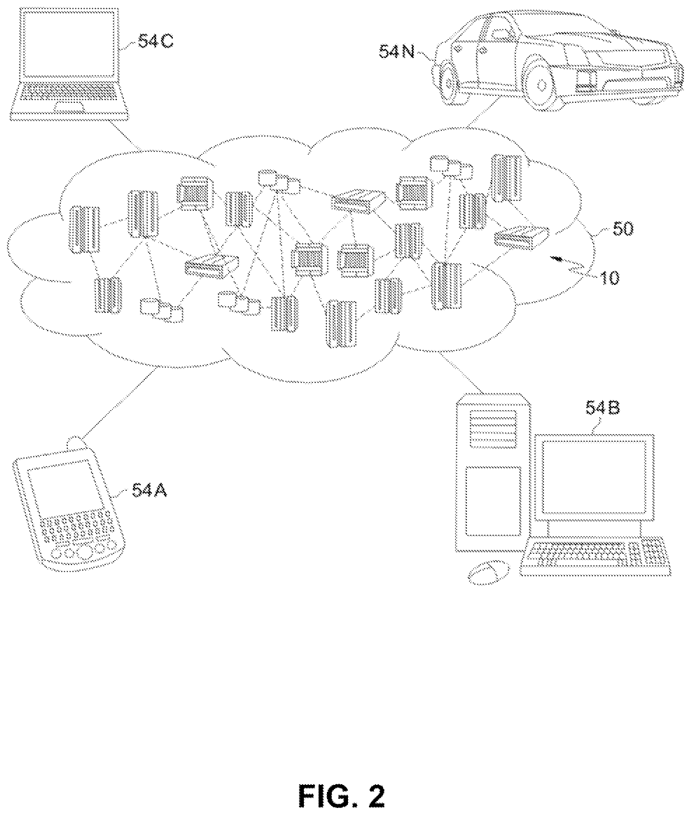

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

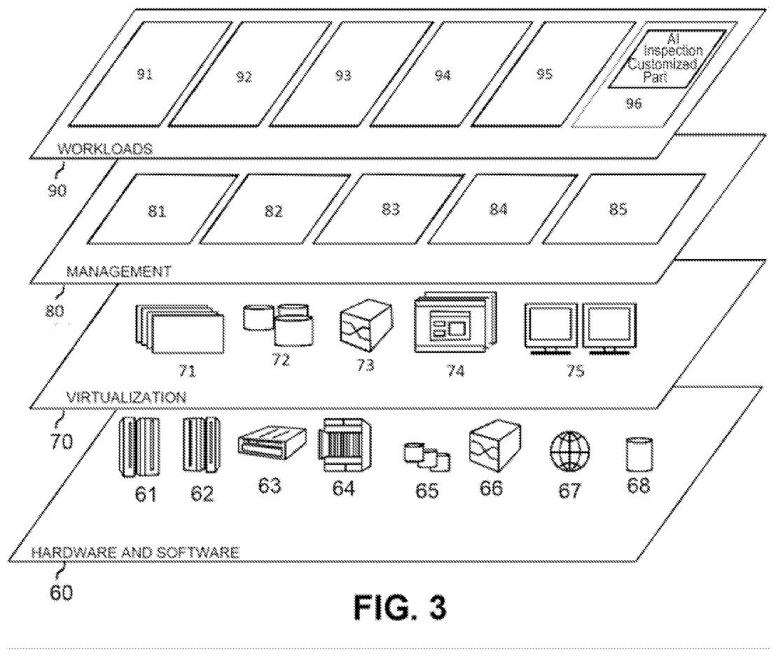

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and AI inspection of customized part processing 96.

Implementations of the invention may include a computer system/server 12 of FIG. 1 in which one or more of the program modules 42 are configured to perform (or cause the computer system/server 12 to perform) one of more functions of the automated AI inspection of custom part production processing 96 of FIG. 3. For example, the one or more of the program modules 42 of the automated AI inspection of custom part production processing 96 may be configured to receive custom part design data, extract features for the custom part from the design data, verify the custom part features during subprocesses of production are in compliance with the features of the custom part extracted from the design data, and generate alerts for noncompliance during subprocesses of production as further described herein in more detail.

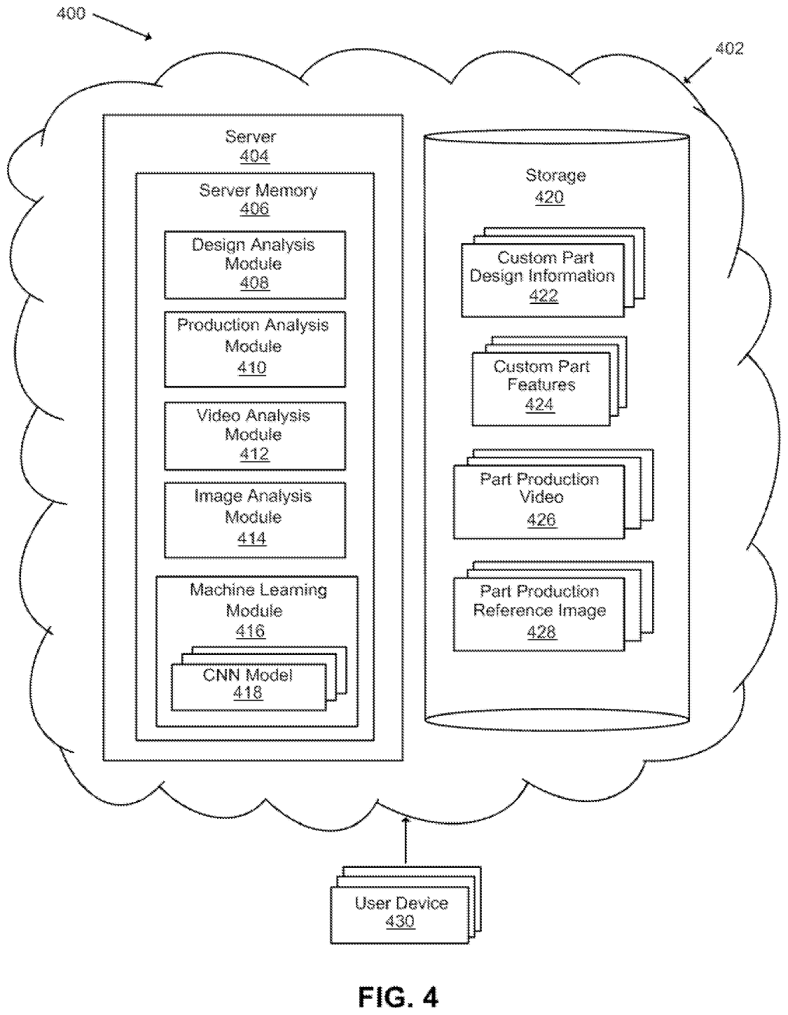

FIG. 4 shows a block diagram of a server in a cloud computing environment in accordance with aspects of the present invention. In embodiments, the cloud computing environment 400 includes a server 404, which may be a computer system such as a computer system 12 described with respect to FIG. 1 and is a cloud computing node such as cloud computing node 10 described with respect to FIG. 2 with which computing devices used by cloud consumers may communicate over a network 402. In general, the server 404 supports services that extract design data such as geometric information from custom part design information, extract features for the custom part from the design data, verify the custom part features during subprocesses of production are in compliance with the features of the custom part extracted from the design data, and generate alerts for noncompliance during subprocesses of production.

The server 404 has a server memory 406 such as memory 28 described with respect to FIG. 1. The server 404 includes, in memory 406, design analysis module 408 having functionality to receive custom part design information, such as CAD files for instance with image data and geometric information, and extract features, such as steps, holes, arcs and so forth, for the custom part from the custom part design information. The server 404 also includes, in memory 406, production analysis module 410 having functionality to receive design information, dimension information, and extracted features for the custom part, receive images of the custom part during subprocesses of part production, select reference images for each subprocess of part production, verify that the custom part features during subprocesses of part production are in compliance with the features of the custom part extracted from the design information or reference images, and generate alerts for noncompliance during subprocesses of part production.

The server 404 includes, in memory 406, video analysis module 412 having functionality to receive video of the part production and provide frames of the video to image analysis module 414. The server 404 also includes, in memory 406, image analysis module 414 having functionality to receive images of video frames, extract image information, including image height, image width and image depth, and provide the images and image information to machine learning module 416.

The server 404 additionally includes, in memory 406, a machine learning module 416 having functionality to receive images and image information and verify that features in an image of the part at each subprocess are in compliance with the features of the custom part extracted from the design information or reference images. The machine learning module 416 includes one of more convolution neural network (CNN) models 418 trained to verify that features in an image of the part at each subprocess in the part production are compliant with the features of the custom part extracted from the design information or reference images.

In embodiments, there may be a CNN trained to receive frames from live video of custom part production and the subprocesses from a reference video, identify the subprocesses performed in the live video of custom part production, and verify that the custom part in the frames from the live video of custom part production for each subprocess are in compliance with reference images for each subprocess. Accordingly, the same network in embodiments can be used to compare multiple subprocesses of custom part production sequentially.

In embodiments, the CNN may be trained using images of the custom part with features that are not in compliance and images of the custom part with features that are compliant with the features of the custom part extracted from the design information or reference images. There may also be a CNN in embodiments for each subprocess of the part production. For example, if a part production has n subprocesses, there may be n CNNs, one for each of the n subprocesses. Each CNN may receive as input an image of the custom part from a live video of the part production and a reference image of the custom part and verify that the features of the image of the custom part from the live video are in compliance with the features of the reference image of the custom part. For instance, for a feature that is a hole with a certain diameter in a specific location of the custom part in the image from the live video, the CNN verifies that the same feature is found in the same location with the same diameter in the reference image of the custom part. In embodiments, each CNN may be trained using images of the custom part with features that are not in compliance and images of the custom part with features that are in compliance with the features of the custom part extracted from the design information or reference images.

In embodiments, design analysis module 408, production analysis module 410, video analysis module 412, image analysis module 414, and machine learning module 416 may comprise one or more program modules such as program modules 42 described with respect to FIG. 1. The server 404 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the invention, FIG. 4 also shows a block diagram of storage 420 in a cloud computing environment. In embodiments, the cloud computing environment 400 includes storage 420, which may be a storage system such as storage system 34 described with respect to FIG. 1. In general, storage 420 may store custom part design information 422 in files, such as images, image data and geometric information defining features, such as steps, holes, arcs and so forth. For example, the custom part design information 422 files can be CAD files with images, image data and geometric information. Storage 420 may also store custom part features 424 in files that include features, such as steps, holes, arcs and so forth, for the custom part extracted from the custom part design information.

Storage 420 may additionally store part production videos 426 that capture activities of subprocesses of part production. For example, subprocesses of a custom part production may include activities such as cutting an arc, drilling a hole, folding material, casting, assembling, packaging, and other part production activities. Storage 420 may further store part production reference images 428 of the custom part for each subprocess of part production that are in compliance with the custom part design information.

The cloud computing environment 400 of FIG. 4 also shows user device 430 that communicates with server 404 and storage 420 over network 402 and may be a computer system such as a computer system 12 described with respect to FIG. 1. The user device 430 has functionality to receive alerts generated by the production analysis module 410 indicating that the custom part in production is not in compliance with the custom part design information.

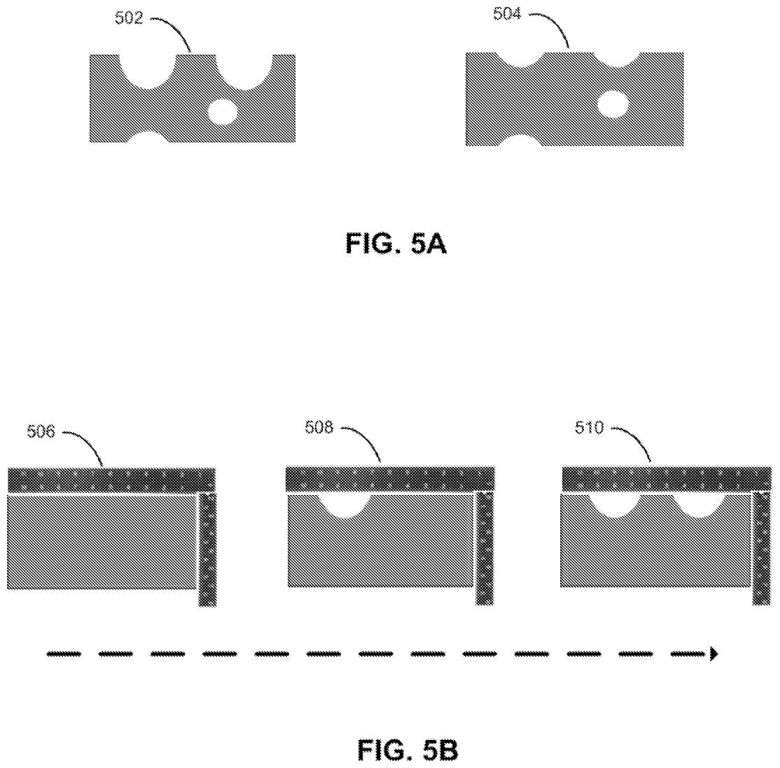

FIGS. 5A-5B depict illustrations of exemplary custom parts in accordance with aspects of the invention. In particular, FIG. 5A depicts an exemplary illustration of generic part 502 that may be mass produced in part production and a custom part 504 that is a modification of the generic part 502 and intended to be produced in small quantity. Generic part 502 has geometric features that include, for example, three (3) curved shapes, one (1) hole, a certain length and a certain width. Custom part 504 has these same geometric features but the three (3) curved shapes are more shallow and the one (1) hole is in a different location than in generic part 502. In this example where custom part 504 is a modification of generic part 502, the general steps or subprocesses in the production process used to make generic part 502 may be used to make custom part 504 with the modifications of more shallow curved shapes and the hole in a different location than in generic part 502.

FIG. 5B depicts an exemplary illustration of inspection and measurement testing of the exemplary custom part between subprocesses of part production. In order to verify that the custom part is in compliance with the specified design and dimensions at each stage of production, the custom part may be inspected and measured between each subprocess of production of the custom part. For example, at reference numeral 506, the length and width of the custom part in production may be measured after cutting the initial form of the custom part, for instance, from a sheet of material specified for the custom part. After cutting one of the curved shapes in the initial form of the custom part, the width, depth and curvature of the curved shape may be measured at reference numeral 508. At reference numeral 510, the width, depth and curvature of the second curved shape may be measured after cutting the second curved shape in the production of the custom part. In this way, measurement of the custom part may verify that the custom part is in compliance with the specified design and dimensions at each stage of production.

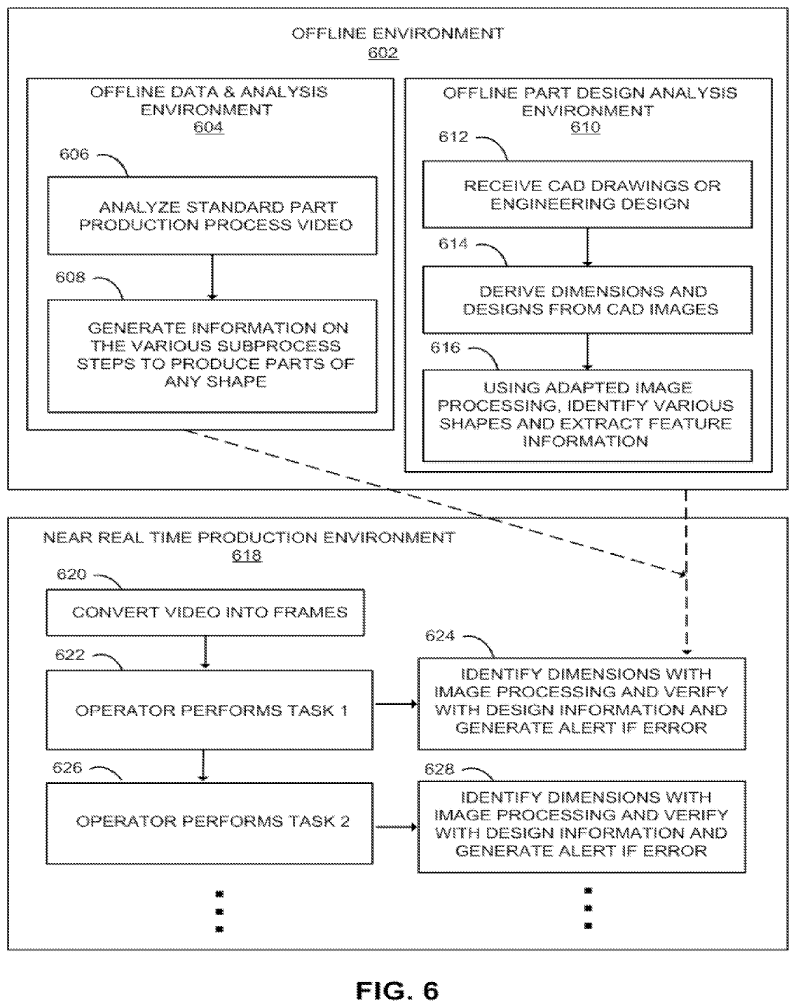

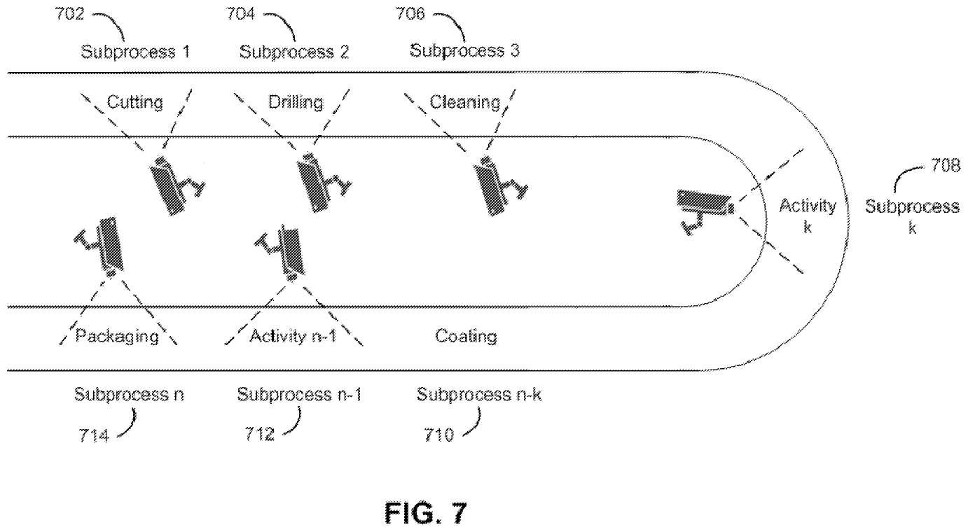

FIG. 6 depicts an illustration of an exemplary process flow diagram for automated artificial intelligent inspection of custom parts in production in accordance with aspects of the invention. In general, the inspection of a custom part during subprocesses of part production may be automated by artificial intelligence, and, in particular, by computer vision and deep learning as described in further detail with respect to FIGS. 7-9.

In embodiments, the process flow diagram of FIG. 6 illustrates steps for automated artificial intelligent inspection of customized parts in production in offline environment 602 and in real time or near real time production environment 618. At step 606, in offline data and analysis environment 604, the system analyzes a standard part production video such as a production video of generic part 502 described with respect to FIG. 5A. At step 608, the system generates information of the various subprocess steps to produce parts of any shape such as generic part 502 or custom part 504, each described with respect to FIG. 5A.

At step 612, in offline part design analysis environment 610, the system receives CAD drawing or engineering designs of a custom part such as custom part 504 described with respect to FIG. 5A. At step 614, the system derives dimensions and designs from design information in embodiments such as CAD images with image data and geometric information from the CAD drawings or engineering designs. At step 616, using adapted image processing, the system identifies various shapes and extracts feature information of the custom part from the design information such as geometric features, for example, of custom part 504 described with respect to FIG. 5A that includes three (3) curved shapes, one (1) hole, a certain length and a certain width.

The feature information extracted in offline environment 602 is used in real time or near real time production environment 618 to verify dimensions of a customized part in production. At step 620 in real time or near real time production environment 618, the system converts video recording production of the custom part into frames. At step 622, the system receives images of an operator performing the first task of the subprocess steps in production of the custom part. For example, the first task may be cutting the initial form of the custom part. At step 624, the system identifies the dimensions of features of the custom part in production in the images of the video with image processing and verifies the dimensions of the features with the design information and generates an alert upon detecting the custom part is not in compliance with the dimensions derived from the design information. For instance, the system may identify the length and width of the initial form of the custom part in production and verify the length and width with the design information. At step 626, the system receives images of an operator performing the second task of the subprocess steps in production of the custom part. For example, the second task may be cutting a curved shape in the initial form of the custom part. At step 628, the system again identifies the dimensions of features of the custom part in production in the images of the video with image processing and verifies the dimensions of features with the design information and generates an alert upon detecting the custom part is not in compliance with the dimensions derived from the design information. For example, the system may identify the width, depth and curvature of the curved shape cut into the initial form of the custom part in production and verify the width, depth and curvature of the curved shape with the design information. In this way, the system processes the images from the video for each of the subprocessing steps performed in production of the custom part. In embodiments, the system in FIG. 6 may comprise a hardware circuit for implementing the steps of FIG. 6.

FIG. 7 depicts an illustration of an exemplary process flow diagram of subprocesses recorded during production of a custom part in accordance with aspects of the invention. More particularly, the process flow diagram of FIG. 7 illustrates exemplary subprocesses that are video recorded for automated artificial intelligent inspection of custom parts in production. At subprocess 1 (702), cutting is performed in production of the custom part. For example, the curved shapes of exemplary custom part 504 described with respect to FIG. 5A may be cut during subprocess 1 (702) of production of exemplary custom part 504. At subprocess 2 (704), drilling is performed in production of the custom part. For instance, the one (1) hole of exemplary custom part 504 described with respect to FIG. 5A may be drilled during subprocess 2 (704) of production of exemplary custom part 504.

Continuing with the subprocesses illustrated in FIG. 7, at subprocess 3 (706) cleaning is performed in the production of the custom part. For instance, any metal shaving may be removed from exemplary custom part 504 described with respect to FIG. 5A from cutting at subprocess 1 (702) and/or drilling at subprocess 2 (704). One or more additional subprocesses may be performed between subprocess 3 (706) and subprocess k (708). At subprocess k (708), activity k may be performed in production of the custom part, for example, such as grinding, polishing and so forth. At subprocess n−k (710), coating of the custom part may be performed. In embodiments, this step may not be video recorded as illustrated in FIG. 7 because the coating process for example may be performed in a spray coating chamber. Those skilled in the art should appreciate that a video recording of the coated custom part may be made, for instance, after subprocess n−k (710) of coating the custom part and before the next subprocess in production of the custom part. One or more additional subprocesses may be performed between subprocess n−k (710) and subprocess n−1 (712). At subprocess n−1 (712), activity n−1 may be performed such as assembly of custom parts for example, and, at subprocess n (714), packaging of the custom part is performed. In embodiments, n and k may be integer values.

Images of the custom part from the video recording at each subprocess in production of the custom part are compared to reference images of the custom part to verify that the custom part is compliant with the dimensions and design derived from the design information. For the first time the custom part is produced, the first video recording of production is made and the features extracted from the design information and image data are used for comparison to the features of the images of the custom part captured at each subprocess in video recording of the initial production of the custom part. Reference images for each subprocess that are in compliance with the dimension and design of the custom part are selected from the images of the custom part captured at each subprocess in video recording of initial production. For subsequent production of the custom part, the reference images selected from the video recording of the initial production for each subprocess that are in compliance with the dimensions and design may be used as the reference images for comparison for each subprocess in the subsequent productions to verify that the custom part is in compliance with the dimensions and design derived from the design information.

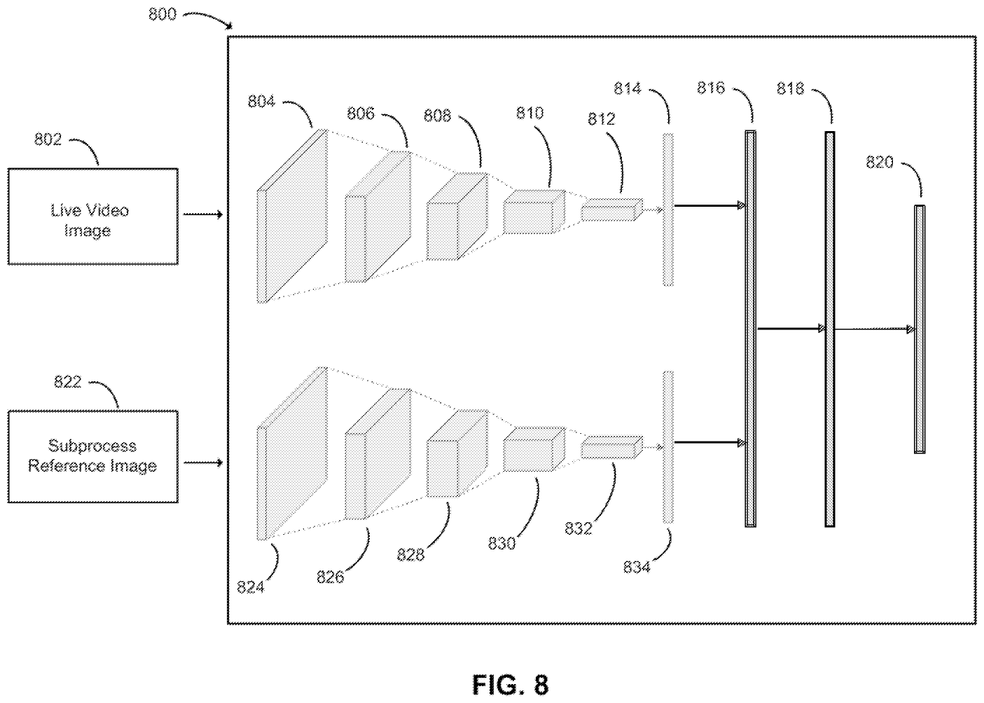

FIG. 8 depicts an illustration of an exemplary machine learning model for automated artificial intelligent inspection of custom parts in production in accordance with aspects of the invention. In particular, FIG. 8 illustrates a similarity CNN model 800 trained to receive frames from live video of custom part production and the subprocesses from a reference video and reference images for each subprocess, identify the subprocesses performed in the live video of custom part production, and verify that the custom part in the frames from the live video of custom part production for each subprocess are similar and accordingly in compliance with the reference image for each subprocess. A live video image 802 from live video of custom part production and subprocess reference image 822 are input into CNN model 800. The similarity CNN model 800 is built on several layers including an input layer, several convolutional and maxpooling layers, and fully connected layers for processing the live video images and for processing each subprocess reference image for each subprocess of the custom part production.

For example, for processing the live video image 802, the input layer 804 is the live video image 802, each convolutional and maxpooling layer that identifies the features in the image of the input layer 804 is shown respectively at reference numerals 806, 808, 810 and 812, and fully connected layers that connect hidden layers to the output layer 820 are shown respectively at reference numerals 814, 816, and 818. For processing the subprocess reference image 822, the input layer 824 is the subprocess reference image 822, each convolutional and maxpooling layer that identifies the features in the image of the input layer 824 is shown respectively at reference numerals 826, 828, 830, and 832, and fully connected layers that connect hidden layers to the output layer 820 are shown respectively at reference numerals 834, 816, and 818. In this similarity network, there can be an input layer, convolutional and maxpooling layers and fully connected layers for each subprocess reference image in each of the subprocesses of production of the custom part as shown for subprocess reference image 822. In this way, the same similarity network can be used to compare multiple subprocesses sequentially.

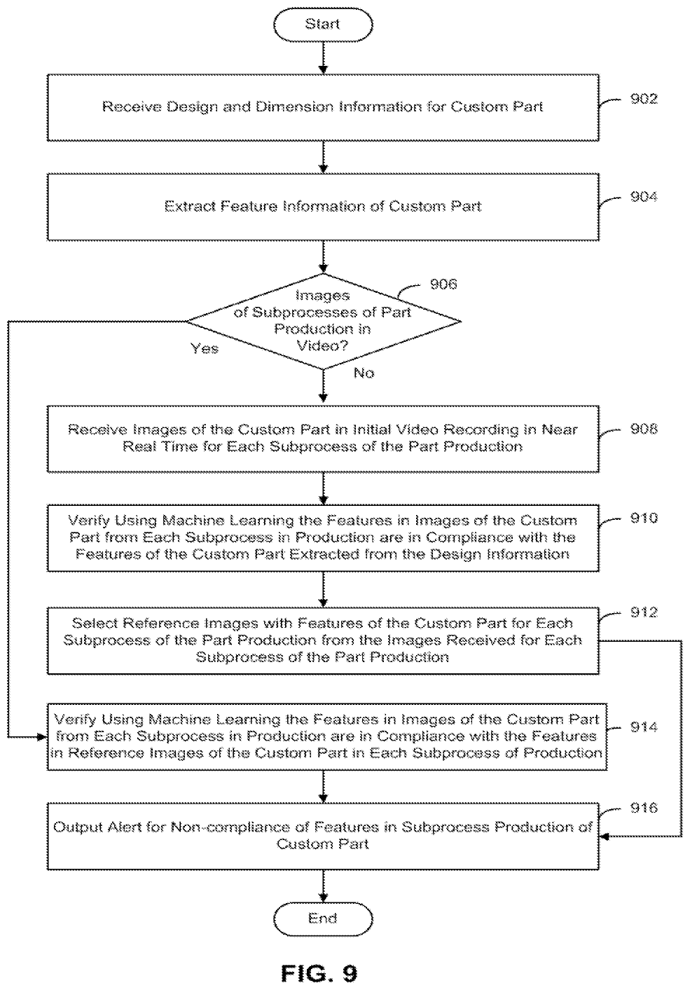

FIG. 9 shows a flowchart and/or block diagram that illustrates the architecture, functionality, and operation of possible implementations of systems, methods, and computer program products according to various embodiments of the present invention. As noted above, each block may represent a module, segment, or portion of instructions, which comprises one or more executable instructions for implementing the specified logical function(s). The functions noted in the blocks may occur out of the order, two blocks shown in succession may, in fact, be accomplished as one step, executed concurrently, substantially concurrently, in a partially or wholly temporally overlapping manner, or the blocks may sometimes be executed in the reverse order, depending upon the functionality involved. And some blocks shown may be executed and other blocks not executed, depending upon the functionality involved.

FIG. 9 shows a flowchart of an exemplary method in accordance with aspects of the present invention. Steps of the method may be carried out in the environment of FIG. 4 and are described with reference to elements depicted in FIG. 4. In particular, the flowchart of FIG. 9 shows an exemplary method for automated artificial intelligent inspection of custom parts in production, in accordance with aspects of the present invention.

At step 902, the system receives design and dimension information for the custom part. The design and dimension information received for the custom part for instance includes CAD files with image data and geometric information. In an embodiment, the design analysis module 408 in server memory 406 described with respect to FIG. 4 receives design and dimension information for the custom part.

At step 904, the system extracts feature information for the custom part from the custom part design information. For example, the system extracts geometric information and features, such as steps, holes, arcs and so forth, for the custom part from the custom part design information. In an embodiment, the design analysis module 408 in server memory 406 described with respect to FIG. 4 extracts design and dimension information for the custom part from the custom part design information.

At step 906, the system determines if there are images of subprocesses of part production from a previous video recording. If there is not any previous video recording the first time the custom part is produced, the features extracted from the design information and image data can be used for comparison to the features of the images of the custom part captured at each subprocess in video recording of the initial production of the custom part. Reference images for each subprocess that are in compliance with the dimension and design of the custom part are selected from the images of the custom part captured at each subprocess in video recording of initial production. For subsequent productions of the custom part, the reference images selected from the video recording of the initial production for each subprocess that are in compliance with the dimensions and design may be used as the reference images for comparison for each subprocess in the subsequent productions to verify that the custom part is in compliance with the dimensions and design derived from the design information. If the system determines that there are images of subprocesses of part production from a previous video recording, then carrying out the steps of the exemplary process flow diagram continues at step 914. Otherwise, carrying out the steps of the exemplary process flow diagram continues at step 908. In an embodiment, the production analysis module 410 in server memory 406 described with respect to FIG. 4 determines if there are images of subprocesses of part production from previous video recording.

At step 908, the system receives images of the custom part in an initial video recording in real time or near real time for each subprocess of the part production. For example, the production of the custom part is video recorded in embodiments that includes video recording of subprocesses of production. In an embodiment, the video analysis module 410 in server memory 406 described with respect to FIG. 4 may receive the images of the custom part in an initial video recording in real time or near real time for each subprocess of the part production.

At step 910, the system verifies, using machine learning, that the features in images of the custom part from each subprocess in production are in compliance with the features of the custom part extracted from the design information. For instance, the system verifies that the diameter and placement of a feature such as a hole in the custom part appearing in images from each subprocess in production is in the same location with the same diameter as the feature of the hole extracted from the design information of the custom part. In an embodiment, the image analysis module 414 and the machine learning module 416 in server memory 406 described with respect to FIG. 4 verifies that the features of the custom part in images from each subprocess in production are in compliance with the features of the custom part extracted from the design information. In embodiments, the machine learning module 416 applies a CNN model trained to verify that the features in images of the custom part from each subprocess in production are in compliance with the features of the custom part extracted from the design information. In embodiments, the production analysis module 410 may receive an indication from the machine learning module 416 or the CNN model 418 that the features are in compliance and the production analysis module 410 may output a notification that the verification of features was successful to a computing device such as user device 430 described with respect to FIG. 4.

At step 912, the system selects reference images with features of the custom part for each subprocess of the part production from images received for each subprocess of the part production. In embodiments, reference images for each subprocess that are in compliance with the dimension and design of the custom part are selected from the images of the custom part captured at each subprocess in video recording of initial production. These reference images with features of the custom part for each subprocess may be saved along with the initial video recording for automated AI inspection of any subsequent production of the custom part. In an embodiment, the image analysis module 414 in server memory 406 described with respect to FIG. 4 selects reference images with features of the custom part for each subprocess of the part production from images received for each subprocess of the part production.

If the system determined that there are images of subprocesses of part production from a previous video recording at step 906, the system verifies using machine learning at step 914 that the features in images of the custom part from each subprocess in production are in compliance with the features in reference images of the custom part in each subprocess of production. For instance, the reference images selected from the previous video recording of production for each subprocess that are in compliance with the dimensions and design may be used as the reference images for comparison for each subprocess in the subsequent productions to verify that the custom part is in compliance with the dimensions and design derived from the design information. In an embodiment, the image analysis module 414 and the machine learning module 416 in server memory 406 described with respect to FIG. 4 verifies that the features of the custom part in images from each subprocess in production are in compliance with the features in reference images of the custom part in each subprocess of production. In embodiments, the machine learning module 416 applies a CNN model trained to receive frames from live video of custom part production and the subprocesses from a reference video and reference images for each subprocess, identify the subprocesses performed in the live video of custom part production, and verify that the custom part in the frames from the live video of custom part production for each subprocess are similar and, accordingly, in compliance with the reference image for each subprocess. In embodiments, the production analysis module 410 may receive an indication from the machine learning module 416 or the CNN model 418 that the features are in compliance and the production analysis module 410 may output a notification that the verification of features was successful to a computing device such as user device 430 described with respect to FIG. 4.

At step 916, the system outputs an alert for non-compliance of features of the custom part detected in each subprocess of production. For instance, the system outputs an alert upon detecting during verification of a feature such as a hole that the diameter and/or placement of the hole is different from the diameter and/or placement of the hole specified in the design information of the custom part. In an embodiment, the production analysis module 410 in server memory 406 described with respect to FIG. 4 outputs an alert for non-compliance of features of the custom part detected in each subprocess of production. In embodiments, the production analysis module 410 may receive an indication from the machine learning module 416 or the CNN model 418 that a feature in the images of the custom part in production is not in compliance and the production analysis module 410 outputs the alert for non-compliance of features to a computing device such as user device 430 described with respect to FIG. 4.

In this way, aspects of the present invention enable automated AI inspection of the custom part during production without prior learning experience and automatically derive subprocess steps of production when the correct custom part is produced.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a processor, design information for a custom part;
extracting, by the processor, feature information of the custom part from the design information;
receiving, by the processor, images of the custom part in production from a recording in near real time; and
verifying, by the processor, using machine learning, that features in the images of the custom part in production are in compliance with the feature information of the custom part from the design information.

2. The method of claim 1, further comprising selecting, by the processor, reference images from the images of the custom part in production that are in compliance with the feature information of the custom part.

3. The method of claim 1, further comprising:
receiving, by the processor, the recording in near real time, wherein the recording is a video recording and is an initial video recording of the custom part in production; and
outputting, by the processor, an alert to a computing device when a feature in the images of the custom part in production is not in compliance with the feature information of the custom part.

4. The method of claim 1, wherein the machine learning comprises applying a convolutional neural network model that identifies subprocesses of the custom part in production from the images of the custom part in production from the recording.

5. The method of claim 1, wherein the machine learning comprises applying a convolutional neural network model that determines the features in the images of the custom part in production are in compliance with an image from the feature information of the custom part.

6. The method of claim 4, wherein the convolutional neural network model is trained to receive the images of the custom part in production from the recording, the subprocesses from a reference video and reference images for each subprocess to identify plural subprocesses of the custom part in production from the images of the custom part in production from the recording.

7. The method of claim 5, wherein the convolutional neural network model is trained to determine that the features in the images of the custom part in production are in compliance using at least one image of the custom part with plural features that are not in compliance with the features of the custom part and at least one image of the custom part with the features that are in compliance with the features of the custom part.

8. The method of claim 1, wherein the verifying using the machine learning comprises applying plural convolutional neural network models that determine the features in the images of the custom part in production are in compliance with an image from the feature information of the custom part in subprocesses of the production.

9. The method of claim 2, further comprising:
verifying, by the processor, using the machine learning in a subsequent production of another custom part that plural features in images of the another custom part in the subsequent production are in compliance with plural features of the reference images.

10. The method of claim 1, further comprising:
storing the recording in a storage system; and
inputting images of the custom part in production from the stored recording in a convolutional neural network model that determines plural features in plural images of another custom part in a subsequent production are in compliance with plural features in the images of the custom part in production from the recording.

11. A computer program product comprising one or more computer readable storage media having program instructions collectively stored on the one or more computer readable storage media, the program instructions executable to:
receive, by a processor, images of a custom part in production from an initial video recording in near real time;
input, by the processor, the images of the custom part in production into a convolutional neural network model that determines features in the images of the custom part are similar with feature information of the custom part;
receive, by the processor, an indication from the convolutional neural network model that a feature in the images of the custom part in production is not similar with the feature information of the custom part; and
output, by the processor, an alert to a computing device in response to receiving the indication that the custom part in production is not in compliance with the feature information of the custom part.

12. The computer program product of claim 11, wherein the program instructions are further executable to:
receive, by the processor, design information for the custom part; and
extract, by the processor, the feature information of the custom part from the design information.

13. The computer program product of claim 11, wherein the convolutional neural network model is trained to receive the images of the custom part in production from the initial video recording, subprocesses of the production of the custom part from a reference video and reference images for each subprocess to identify plural subprocesses of the custom part in production from the images of the custom part in production from the initial video recording.

14. The computer program product of claim 11, wherein the convolutional neural network model is trained to receive the images of the custom part in production from the initial video recording and subprocesses of the production of the custom part from a reference video to determine the features in the images of the custom part are similar with the feature information of the custom part.

15. The computer program product of claim 11, wherein the program instructions are further executable to:
store the initial video recording in a storage system; and
input images of the custom part in the production from the stored initial video recording in a convolutional neural network model that determines plural features in plural images of another custom part in a subsequent production are in compliance with plural features in the images of the custom part in production from the initial video recording.

16. A system comprising:
a processor, a computer readable memory, one or more computer readable storage media, and program instructions collectively stored on the one or more computer readable storage media, the program instructions executable to:
receive, by the processor, images of a custom part in production from an initial video recording in near real time;
input, by the processor, the images of the custom part in production into a machine learning model that determines features in the images of the custom part are similar with feature information of the custom part;
receive, by the processor, an indication from the machine learning model that a feature in the images of the custom part in production is not similar with the feature information of the custom part; and
output, by the processor, an alert to a computing device in response to receiving the indication that the custom part in production is not in compliance with the feature information of the custom part.

17. The system of claim 16, wherein the program instructions are further executable to:
receive, by the processor, design information for the custom part; and
extract, by the processor, the feature information of the custom part from the design information.

18. The system of claim 16, wherein the machine learning model comprises a convolutional neural network model that determines the features in the images of the custom part in production are similar with the feature information of the custom part.

19. The system of claim 16, wherein the machine learning model is trained to receive the images of the custom part in production from the initial video recording and subprocesses of the production of the custom part from a reference video to determine the features in the images of the custom part are similar with the feature information of the custom part.

20. The system of claim 16, wherein the program instructions are further executable to:
store the initial video recording in a storage system; and
input images of the custom part in production from the stored initial video recording in the machine learning model that determines plural features in plural images of another custom part in a subsequent production are similar with plural features in the images of the custom part in production from the initial video recording.
